(19) United States
(12) Patent Application Publication
(10) Pub. No.: US 2026/0154508 A1
(43) Pub. Date: Jun. 4, 2026

(54) SYSTEMS AND METHODS FOR MACHINE LEARNING BASED ANALYSIS OF RACING COMMUNICATION IN A RACING EVENT

(71) Applicants: Constructor Technology AG, Schaffhausen (CH); Constructor Education and Research Genossenschaft, Schaffhausen (CH)

(72) Inventors: Sergey ULASEN, Singapore (SG); Andrei BOIAROV, Sofia (BG); Artem SHAPIRO, Dnipro (UA); Serg BELL, Singapore (SG); Stanislav PROTASOV, Singapore (SG); Nikolay DOBROVOLSKIY, Alanya (TR); Laurent DEDENIS, Geneve (CH)

(21) Appl. No.: 18/966,782

(22) Filed: Dec. 3, 2024

(51) Int. Cl. G06F 40/35; G06F 40/103; G10L 25/78

(52) U.S. Cl. CPC G06F 40/35; G06F 40/103; G10L 25/78

(57) ABSTRACT

Disclosed herein are systems and method for ML-based analysis of racing communications. In one aspect, the method includes: obtaining a plurality of audio message between a plurality of race team members, converting the messages into text format, determining roles of speakers, including at least one of: determining roles of some speakers based on analysis of specific words and/or phrases, and determining roles of other speakers based on analysis of background noise patterns in audio messages, recognizing topics of messages by applying a third neural network trained on racing data, identifying a list of predefined keywordsin the text messages, determining a level of importance of each message based on the role of the speaker, the topic of the message, the predefined keywords, and a relationship of the message with other messages, and displaying the plurality of text messages based on the level of importance in a user interface.

### FIELD OF TECHNOLOGY

The present disclosure relates to the field of machine learning, and, more specifically to methods and systems for transcribing, tracking, and analyzing live radio communication between racing team members during a race.

### BACKGROUND

Racing events, such as car, boat or bicycle racing, involve a variety of team members other than an individual racer, working together to win the race, with each member having a predefined role. For example, for car racing events, the team members may include a driver and any number of engineers, pit crew, spotters, etc. The drivers, engineers, pit crew, spotters, and so on, each have their own respective roles. For bicycle races, the team members may include riders, engineers, spotters, water crew, etc. Thus, constant communication among the team members is essential during a race. When multiple vehicles are involved in the racing activity, it is necessary to coordinate stops and starts for the different vehicles, care to drivers/riders, and ensure safety of all members while maintaining the excitement of the event. One approach is to allow communication among the various members to be directed to every other member. However, there may be a large volume of redundant messages (e.g., messages that do not carry useful information about the state of other team). As an example, a spotter simply informing a driver of his or her position on the track may not be a particularly useful message, yet a spotter is speaking most frequently on the radio communications (e.g., approximately 60-70% of the messages). Each member receiving the messages will then be tasked with determining the relevance of each message to his/her role, sort the messages, and act on the messages. As can be readily understood, this process is labor intensive and inevitably delays actions. Thus, there is a need for improving communication for racing activities such that messages are acted upon based on their level of importance and urgency.

### SUMMARY

To address the shortcomings of not filtering all audio communication between team members during a race, the present disclosure describes a near real-time voice recognition system configured to transcribe, trac, and analyze live radio communication between racers and their support teams during races. The present disclosure addresses the significant challenge of managing and interpreting the vast amount of voice data that is generated during races. Some of the technical improvements of the present disclosure is the ability to utilize neural networks (NN) or other machine learning (ML)-based models to identify and highlight key messages within the live radio communication during a race. In particular, the present disclosure applies trained NN models to identify the roles of speakers based on detecting words and/or phrases or based on hearing background noise patterns in the audio messages. In addition, the present disclosure also applies a NN model to recognize topics within the texts for determining what communication is important and what communication may be filtered out. Thus, the present disclosure provides a platform for team members to monitor all voice communication in near real-time, filter out irrelevant information, and highlight the important information to allow team members to make data-driven decisions that can influence the racing team's strategy in real-time during a race.

In one exemplary aspect, the techniques described herein relate to a method for machine learning (ML) based analysis of racing communications, the method including: obtaining a plurality of audio message between a plurality of race team members, converting the plurality of audio messages into text format, determining roles of one or more speakers in the messages, including at least one of: applying a first neural network to the plurality of converted text messages to determine roles of some speakers based on analysis of specific words and/or phrases in the text messages, and applying a second neural network to the plurality of audio messages to determine roles of other speakers based on analysis of background noise patterns in the audio messages, recognizing topics of the messages by applying a third neural network trained on racing data to the plurality of converted text messages, identifying a list of predefined keywords, by text search mechanism, in the text messages, determining a level of importance of each message based on the role of the speaker, the topic of the message, the predefined keywords identified in the text message, and a relationship of the message with one or more other messages, and displaying the plurality of text messages based on the level of importance in a user interface (UI).

In some aspects, the displaying the messages to the team member further includes: displaying a role of the speaker, highlighting the identified keywords contained in the message, and identifying the level of importance of the topic of the message.

In some aspects, the list of predefined keywords in the text messages and the roles of the one or more speakers in the messages is determined using a customized topic classification model to build a customized topic model for the type of racing.

In some aspects, the method further comprises: capturing telemetric information for a vehicle of a race, and displaying the telemetric information in the UI.

In some aspect, the training of the first neural network to identify the roles of some speakers includes: training a large language model using phrases used by race team members having specific roles based on recognition of phrases used by the one or more race team members using an automatic speech recognition engine, and fine-tuning the resulting large language model using a race dataset using Low-Rank Adaptation (LoRA) techniques.

In some aspects, the training of the second neural network to identify roles of other speakers is based on one or more audio clips produced by VAD (Voice Activity Detection).

In some aspects, the UI enables a team member of the one or more race team members to switch among messages from different vehicles of the racing event.

In some aspects, the UI further includes one or more interfaces for displaying real-time videos of each respective vehicle in a race.

In some aspects, the UI further includes a map showing a geolocation of the vehicle on a track of the race.

In some aspects, the UI further includes one or more interfaces for receiving telemetry data for each vehicle during the racing event, the telemetry data including at least one of: a speed of the vehicle, an acceleration of the vehicle, a number of laps of the vehicle, a geolocation of the vehicle, and parameters of the vehicle.

In some aspects, the analysis of the race communication and display of text messages on the UI is performed in real-time during a race.

It should be noted that the methods described above may be implemented in a system comprising a hardware processor. Alternatively, the methods may be implemented using computer executable instructions of a non-transitory computer readable medium.

In some aspects, the techniques described herein relate to a system for machine learning (ML) based analysis of racing communications, including: at least one memory; at least one hardware processor coupled with the at least one memory and configured, individually or in combination, to: obtain a plurality of audio message between a plurality of race team members, convert the plurality of audio messages into text format, determine roles of one or more speakers in the messages, including at least one of: applying a first neural network to the plurality of converted text messages to determine roles of some speakers based on analysis of specific words and/or phrases in the text messages, and applying a second neural network to the plurality of audio messages to determine roles of other speakers based on analysis of background noise patterns in the audio messages, recognize topics of the messages by applying a third neural network trained on racing data to the plurality of converted text messages, identify a list of predefined keywords, by text search mechanism, in the text messages, determine a level of importance of each message based on the role of the speaker, the topic of the message, the predefined keywords identified in the text message, and a relationship of the message with one or more other messages, and display the plurality of text messages based on the level of importance in a UI.

In some aspects, the techniques described herein relate to a non-transitory computer readable medium storing thereon computer executable instructions for ML based analysis of racing communications, including instructions for: obtaining a plurality of audio message between a plurality of race team members, converting the plurality of audio messages into text format, determining roles of one or more speakers in the messages, including at least one of: applying a first neural network to the plurality of converted text messages to determine roles of some speakers based on analysis of specific words and/or phrases in the text messages, and applying a second neural network to the plurality of audio messages to determine roles of other speakers based on analysis of background noise patterns in the audio messages, recognizing topics of the messages by applying a third neural network trained on racing data to the plurality of converted text messages, identifying a list of predefined keywords, by text search mechanism, in the text messages, determining a level of importance of each message based on the role of the speaker, the topic of the message, the predefined keywords identified in the text message, and a relationship of the message with one or more other messages, and displaying the plurality of text messages based on the level of importance in a UI.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for machine learning (ML) based analysis of racing communications and displaying messages, in accordance with aspects of the present disclosure.

FIG. 2 is a block diagram illustrating a system for training neural networks to identify speaker roles based on words and/or phrases and for recognizing topics based on racing data in accordance with aspects of the present disclosure.

FIG. 3 is a flow diagram of a method for ML based analysis of racing communications, in accordance with aspects of the present disclosure.

FIGS. 4A-B illustrate an exemplary screenshot of a user interface (UI) displaying a transcript from near real-time audio communication of team members in accordance with aspects of the present disclosure.

FIG. 5 illustrates an exemplary screenshot being displayed via the UI to a team member in accordance with aspects of the present disclosure.

FIG. 6 illustrates an exemplary screenshot being displayed via the UI to a team member in accordance with aspects of the present disclosure.

FIG. 7 presents an example of a general-purpose computer system on which aspects of the present disclosure can be implemented.

### DETAILED DESCRIPTION

Exemplary aspects are described herein in the context of a system, method, and computer program product for machine learning (ML) based analysis of racing communications. Each type of racing event has a list of team members essential for success of the event. A racing team may consist of racers and their support teams including at least driver, spotter, engineers, coaches/managers, and various other support team members. During the race, the racing team is in constant communication with each other via headsets or other communication devices. Communication among racers and race support team members is crucial for several reasons. Effective communication ensures that the team can respond quickly to changing conditions, optimize performance, and maintain safety for the racer. As a non-limiting example, spotters may advise on real-time strategy adjustments due to dynamically changing weather conditions, track conditions, or competitor actions or alert drivers to hazards (e.g., debris, accidents, or weather conditions) on the track. As another non-limiting example, an engineer may receive real-time telemetric data from the racing car including information on engine performance, tire wear, and/or fuel levels. By communicating this type of telemetric data to drivers will allow the drivers to adjust their driving styles to optimize performance.

However, since there are so many team members and so much communication, a radio communication channel may contain a lot of redundant or less vital information. For example, on average an audio transmission may occur every 3 seconds during the race. In addition, there may be 120 different phrases uttered by multiple people per minute during a race. This is compounded by the fact that in critical situations there may be up to hundreds of unique messages per minute. It is in these critical situations, where the driver or key members of the support team will need to be alerted to the most important messages. Finally, a race may span multiple days (e.g., 12+ hours of audio) such that there may be dozens of hours of total speech time by all racing team members. Thus, it is important to track, manage, and interpret the vast amount of voice data that is generated and broadcasted to racers and their support team in real-time during races.

In one aspect, communication among all members of a team associated with a racing activity is monitored during a race. The communication is analyzed and the audio messages are transcribed and displayed to members of the team based on levels of importance assigned to the messages for each respective team, or team member. For the present disclosure, a racing event may be for any type of vehicle. Thus, the event may comprise a car racing event, a boat racing event, a bicycle racing event, an airplane racing event, etc. Each type of racing event has a list of team members with their own particular roles that are essential to a successful race.

As a non-limiting example, a team of car racers may include roles including at least a driver, a spotter, and a group of engineers. The driver is a single person and, generally, their communication is the most important communication to pay attention to, but the communication of the driver may only account for 10-20% of all audio clips. The spotter may typically be a single person who is talking about the condition of the track to the team. For example, the spotter may be talking about which car is where, how far the car is, etc. Although, generally, the spotter accounts for 50-60% of the audio clips, the majority of the communication from the spotter may be labeled as trivial or not important (as compared to the rest of the communications). The engineers may be a group of people who are talking about pitting and race strategy. The engineers may have important communications and may account for 20-30% of the audio clips. However, since there is an entire group of engineers, there may be redundant communications or other communications between the engineers that may not be important.

Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

The present disclosure describes a technical solution for providing analysis of racing communication using computer networks that include components used for implementing any type of machine learning model, including Artificial Intelligence (AI) based machine learning models. In addition, the present disclosure provides an advantage over similar audio communication systems by enabling team members to monitor all voice communication in near real-time in order to filter out irrelevant information (e.g., unimportant communication) and highlight the important information. In this way, team members and racers can make data-driven decisions that may influence the racing strategy and outcome of the race.

It should be noted that the present disclosure describes a racing event with cars for illustrative purposes only and that the racing event may be involve any type of vehicle or even racing without a vehicle such as a biker, runner, swimmer, or the like. Thus, the present disclosure may be applied to any racing event including a car racing event, a boat racing event, a bicycle racing event, an airplane racing event, etc. or racing without using a vehicle.

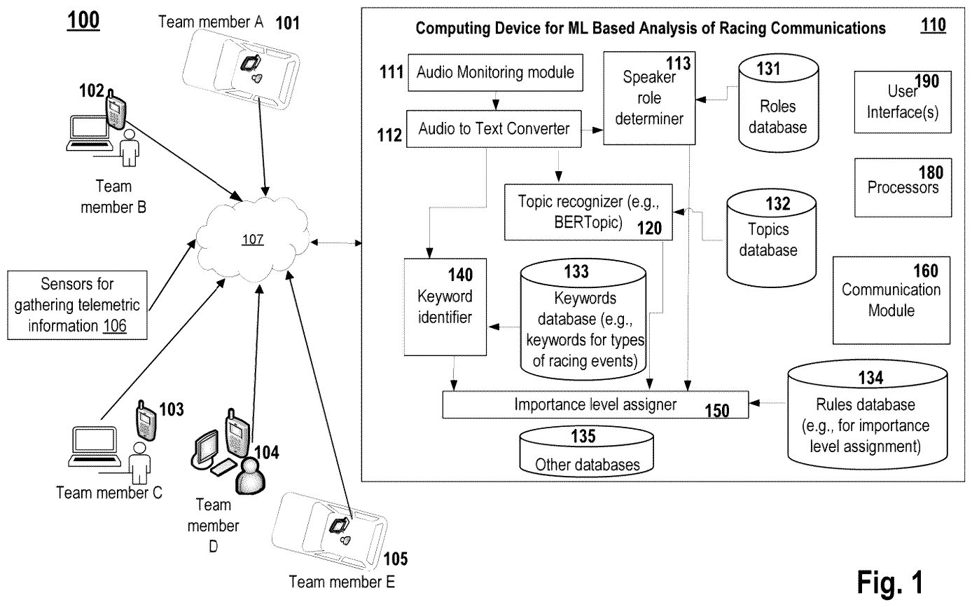

FIG. 1 is a block diagram illustrating a system 100 for machine learning (ML) based analysis of racing communications and displaying messages based on a level of importance assigned to each respective message. In one aspect, the system 100 includes a computing device 110 for performing ML based analysis, user devices 101-105 corresponding to various team members of a racing team, and sensors 106 configured to gather telemetric information from vehicles or equipment of the racers.

The user devices 101-105 are used for obtaining audio messages of team members A-E, respectively, and for displaying messages of the respective team members in near-real time. In one aspect, the sensors 106 are placed directly on the vehicles or racing equipment and configured to capture telemetric information of the vehicle or racing equipment during the race.

In one aspect, the user devices 101-105 include, for example, a mobile computing device, a cellular telephone, a smart phone, a desktop computer, a notebook computer, a laptop computer, a tablet computer, a computing device embedded in a vehicle, and other forms of computing devices. In one aspect, a display module is integrated in the user devices 101-105.

In one aspect, the computing device 110 for ML based analysis of racing communications and is configured to perform a few key functions. First, the computing device 110 is configured to perform real-time transcription to convert spoken communication into text with an acceptable latency for ensuring that no messages are missed during a race. Second, the computing device 110 is configured to identify and highlight key messages from all spoken communication based on predefined criteria set by the racing time. In addition, messages can be determined to be key by using an automatic importance detection mechanism to allow the team to focus on critical information. Third, the computing device 110 may be configured to offer a user-friendly user interface (UI) that displays key messages (e.g., messages identified as important). Finally, the computing device 110 is configured to provide a comprehensive recording and overview of all communications for a post-race analysis.

In one aspect, the computing device 110 includes at least: an audio monitoring module 111, an audio to text converter 112, a speaker role determiner 113 communicatively coupled to a roles database 131, a topic recognizer 120 communicatively coupled to a topics database 132, a keyword identifier 140 communicatively coupled to a keywords database 133, an importance level assigner 150 communicatively couple to a rules database 134, a communication module 160, any number of processors 180, User Interface(s) 190, and other databases 135. In one aspect, the computing device 110 may be deployed on a cloud server or a local machine.

The roles database 131, topics database 132, a keywords database 133, and/or rules database 134 may be populated by the user. For example, rules for assigning a level of importance to messages based on the speaker role, topic, keywords, etc. may be determined by the user and stored in the rules database 134.

In one aspect, the system 100 includes a plurality of user devices 101-105 configured to capture audio data and transmit the raw audio data to the computing device 110 via the Internet, streaming service, or cloud server 107 for further processing and analysis. In some examples, the captured audio data from the sensors is first transmitted to a computing device 110 or a server 107 before streams are obtained over the Internet.

The computing device 110 may execute an audio monitoring module 111 that receives the raw (e.g., unprocessed) audio data from the plurality of user devices 101-105. The audio monitoring module 111 may also perform real-time audio data collection and analysis to ensure that the raw audio data from the plurality of user devices 101-105 is not significantly compressed or altered. In one aspect, the audio monitoring module 111 may also convert the audio data obtained from the plurality of user devices 101-105 via the Internet, streaming service, or cloud server 107 into a raw format. In one aspect, the audio monitoring module 111 may also provide real-time access to the audio being captured from the plurality of user devices 101-105 to allow for immediate monitoring and analysis. In addition, the audio monitoring module 111 may ensure minimal delay between the audio capture and the processing to maintain real-time performance. In one aspect, the audio monitoring module 111 may also record the captured audio data for storage in the database 135 for future analysis, playback, training, or archival purposes. In one aspect, the audio monitoring module 111 may tag the raw audio data with metadata such as timestamps, device information, user identifiers. In particular, the raw audio data may be used as training data for machine learning models used in speech recognition for particular users, audio classification for roles, and other AI applications.

In some examples, the raw audio data stream may include audio streams from several devices that are mux-ed into a single audio stream. The audio monitoring module is configured to recognize different speakers from the single audio stream. Accordingly, the audio streams from the team member A 101, team member B 102, team member C 103, team member D 104, or team member E 105 can be mux-ed into a single audio stream on a Internet, streaming service, or cloud server 107 such that a single audio stream is input into the computing device 110.

The computing device 110 may execute the audio to text converter 112 to convert the raw audio data or tagged audio data received from the audio monitoring module 111 to text format. The audio to text converter 112 may utilize any known speech-to-text (STT) or automatic speech recognition (ASR) system that converts spoken language or audio files into written text. At a high level, the audio to text converter 112 may involve a multi-step process that includes feature extraction, acoustic and language modeling, decoding, and post-processing. By leveraging advanced algorithms and models, the audio to text converter 112 can accurately transcribe the raw audio data into written text for analysis by the keyword identifier 140, the topic recognizer 120, or the speaker role determiner 113.

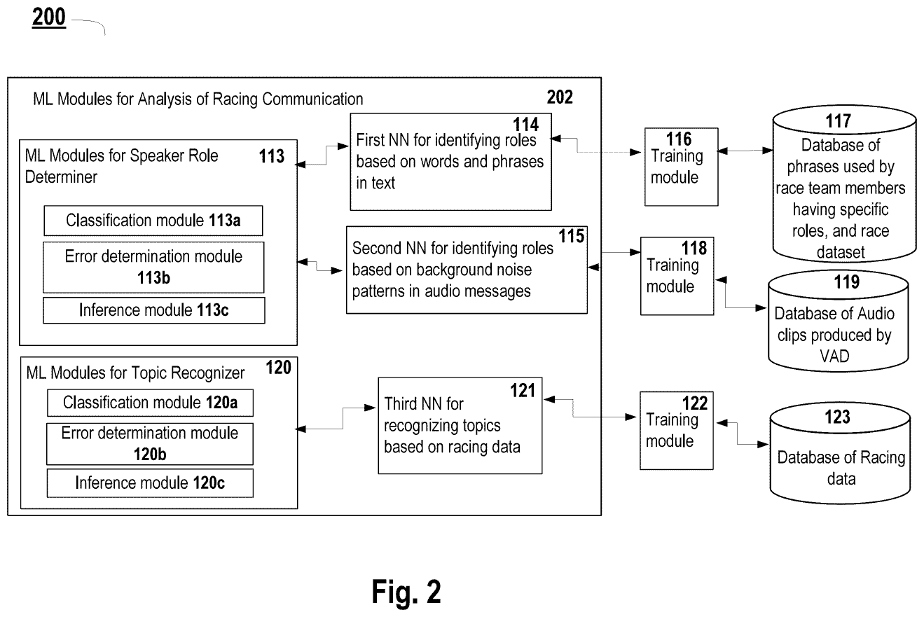

The computing device 110 may execute the trained speaker role determiner 113 (e.g., the ML Modules for Speaker Role Determiner 113 shown in FIG. 2) to process the text messages to identify the role for a particular message transcribed for a user. As a non-limiting, for car racing, the speaker role may be that of a driver, spotter, engineer, etc. The driver is the person who is driving the vehicle and the engineers rely on the driver to inform them about how the vehicle is handling. The spotter is a person who is tasked with monitoring the conditions of the track and other racers on the track. The spotter usually has a bird's eye view of the race track so the driver relies on the spotter to see can things that the driver or engineers cannot. The engineers are tasked with monitoring telemetric data from the racecar such that the driver relies on the engineers to ensure that the vehicle is operating at optimal levels.

Based on using historical data and machine learning, historical communication from the people in different roles can be analyzed by machine learning algorithms to extract common phrases that are unique to their respective roles. For example, phrases that a driver may say during a race may include “copy that”, “I was feeling tight,” or “I feel good.” As another example, phrases that a spotter commonly says during a race may include “clear”, “42 chasing 66” or “bottom.” As yet another example, phrases that engineers say during a race may include talking about car parts or car speeds, “lighting to 3”, or “save fuel.” Accordingly, machine learning may take advantage of these patterns and characteristics of typical phrases said by certain roles to predict whether the near real-time transcribed message is coming from a driver, a spotter, or engineers.

The computing device 110 may execute the topic recognizer 120 (e.g., the ML Modules for Topic Recognizer 120 shown in FIG. 2) to process the text messages to identify the topics for a particular message transcribed for a user. As an example, the topic may be regarding a pitstop, a particular race, weather conditions, fuel level, etc.

The computing device 110 may execute the keyword identifier 140 (e.g., the ML Modules for Topic Recognizer 120 shown in FIG. 2) to process the text messages to identify keywords in the text messages. These keywords may be used to determine important messages and to filter out less important messages for display to the team members. For example, the keywords may be “hotwords” words detected in the text messages, such as lap number, time for stopping, conditions of tires, etc.

The computing device 110 may execute the important level assigner 150 to assign an importance to messages based on the outputs of the speaker role determiner 113, topic recognizer 120, and keyword identifier 140. The messages may then be displayed to team members according to their respective levels of importance. As an example, an example of a UI used to display transcribed messages and use visual indicators to highlight “important” messages and filter out redundant or “unimportant” messages.

In one aspect, the communication module 160 identifies the team members that need to receive the messages and transmits the messages to the corresponding team members. For example, if the driver needs to know about weather conditions and the message has been determined to be a high level of importance, the message may be singled out and transmitted to the spotter.

The UI 190 is used for enabling interactions among team members and the computing device 110. For instance, via the UI 190, a team member may issue queries to the computing device 110, receive responses from the computing device 110, and provide selections to the computing device 110. For example, if a team member wants to view messages related to brakes, the team members may issue a selection of a topic. Then messages related to brakes may be displayed according to their levels of importance. In another example, if a team member wants to view messages related to pitstops, messages related to pitstops may be displayed according to their levels of importance.

In one aspect, the UI 190 includes filters for one or more of: selecting a vehicle for which to display messages, selecting a role of a speaker of the message to be displayed (for e.g., message of the driver, rider, pit crew, engineer), selecting a level of importance of the messages to be displayed, selecting a level of importance of messages to be displayed for each role, selecting to highlight keywords in messages being displayed, providing a selection of a timeline of the race for dynamic displaying of messages for the selected timeline, and searching for specific messages (e.g., messages regarding safety, temperature, conditions of vehicle).

In one aspect, the UI 190 enables the team member to switch among messages from different vehicles in the racing event.

In one aspect, the UI 190 may be configured to playback audio of the messages and/or listen to the original audio stream.

In one aspect, the UI 190 further includes one or more interfaces for receiving real-time videos of each respective vehicle. In one aspect, the real-time video of a vehicle may include a map showing a geolocation of a respective vehicle, such as a boat on a waterway, a car on a track of the race, etc.

In one aspect, the UI 190 further includes one or more interfaces for receiving telemetry data for each vehicle. In one aspect, for a race car, the telemetry data may include one or more of: a speed, an acceleration, a number of laps, a geolocation, and other parameters, etc. Then, one or more UIs may be used for gathering the speed, acceleration, number of laps, geolocation, other parameters associated with the respective cars.

In one aspect, the UI 190 further includes one or more interfaces for receiving realtime videos of the race from each respective vehicle.

Although only five devices 101-105 are shown in the system 100 of FIG. 1, one skilled in the art will appreciate that any number of devices for any number of racers may be used.

FIG. 2 is a block diagram illustrating a system 200 for training neural networks to identify speaker roles based on words and/or phrases and for recognizing topics based on racing data. As shown in FIG. 2, ML modules 202 are configured to build and train specialized neural networks with inference to identify speaker roles and recognize topics. This enables the specialized neural network models to develop an ability to identify roles based on recognizing words and/or phrases in new text, to identify roles based on new background noise patterns of the audio messages, and recognize topics based on unseen racing data. By subjecting the specialized neural network models to large amounts of labeled trained datasets of phrases, audio clips, or racing data, the specialized neural networks may detect and identify roles and topics within data based on supervised learning or unsupervised learning, which will be described in more detail below.

In one aspect, the system 200 contains at least a database 117 of phrases used by race team members having specific roles and race datasets, a database of audio clips produced by a voice activity detection (VAD) 119, and a database or racing data 123. Each of these databases may contain training data that is transmitted into the respective training modules 116, 118, 122. In one aspects, a training dataset of phrases may contain phases and/or words and race dataset and a corresponding role label identifying the roles that frequency use the phrases and/or words during a race. In one aspect, a training dataset of audio clips may contain audio clips and a corresponding role label identifying the roles that are captured in the audio clips. In one aspect, a training set may contain racing data and a corresponding topic label for each racing data.

In one aspect, the ML modules 202 include: a first neural network 114 for identifying roles based on words and phrases from text, a second neural network 115 for identifying roles based on background noise patterns in the audio messages, ML modules for the speaker role determiner 113, a third neural network 120 for recognizing topics based on racing data, and ML modules for the topic recognizer. Each of the ML modules includes a respective classification module 113a, 120a, error determination module 113b, 120b, and an inference module 113c, 120c.

The training modules 116, 118, 122 are the scripts or code that train the modules for a particular task or objective. In one aspect, the training module 116 may be a script or code that holds the instructions on how the first NN 114 for identifying roles based on words and phrases in text should be trained (e.g., classification method, error determination method, etc.) and also runs the training. The training module 116 takes as input the raw training data from the database 117 and trains the first NN 114 to identify roles based on words and phrases in text. As an example, phrases and/or words such as “engine check”, “manage your tires”, or “sensing high temperatures” are known to be frequently used by engineers during a race. Accordingly, the first NN 114 may predict text that contains words or phrases frequently used by an engineer is most likely audio coming from an engineer during the race. As another example, phases and/or words such as “overtake this car”, “copy that” or “feel good” are known to be frequently used by racers during the race. Accordingly, the first NN 114 may predict text that contains words or phrases frequently used by a racer is most likely audio coming from a racer during the race.

In one aspect, the first NN 114 is trained, via the training module 116, to identify roles of some speakers by: (1) training a large language model (LLM) using phrases used by race team members having specific roles based on recognition of phrases used by the one or more race team members using an automatic speech recognition engine, and (2) fine-tuning the resulting large language model using a race dataset using LoRA techniques. In one aspect, the race dataset and the phrases used by race team members having specific roles may be previously stored in database 117.

LLMs such as GPT-3, BERT, and their successors are advanced neural networks designed to understand and generate human language. These models are built using deep learning techniques, particularly transformer architectures, and are trained on vast amounts of text data.

LoRA techniques provide an efficient way to adapt large pre-trained models to new tasks or domains by leveraging low-rank matrix approximations to efficiently fine-tine large models without needing to update all parameters. By leveraging low-rank matrix approximations, these LoRA techniques reduce computational and memory requirements, making it feasible to fine-tune large models on resource-constrained devices.

In one aspect, the second NN 115 is trained, via the training module 118, to identify roles of other speakers based on one or more audio clips produced by VAD (Voice Activity Detection). The audio clips may be previously stored in database 119.

VADs are a technology used to determine whether a segment of audio contains speech or is just background noise. VAD helps to focus on relevant speech segments and ignore non-speech parts. VAD algorithms may rely on various features extracted from the audio signal to make decisions. In one aspect, the features may include energy-based features such as short-time energy to measure the energy of the audio signal over short time frames since speech segments generally have higher energy compared to silence or background noise, and zero-crossing rate to count the number of times the audio signal crosses the zero amplitude line within a frame since speech tends to have a higher zero-crossing rate than silence. In addition, the features may also include frequency-based features such as spectral entropy to measure the randomness of the power distribution in a frequency spectrum since speech has a more structured spectral pattern compared to noise or mel-frequency cepstral coefficients to capture the power spectrum of the audio signal in a way that mimics human auditory perception. Features such as statistical features may also use variance and standard deviation to statistically measure the audio signal's amplitude or frequency component to help distinguish speech from noise.

VAD may also utilize machine learning techniques to distinguish between speech and non-speech. For example, neural networks such as Convolutional Neural Networks (CNNs) or Recurrent Neural Networks (RNNs) can be trained on labeled audio data to classify segments as speech or non-speech. In addition, support vector machines (SVMs) may be trained to distinguish between speech and non-speech based on extracted features.

In one aspect, the training module 118 may be a script or code that holds the instructions on how the second NN for identifying roles based on background noise patterns in audio messages should be trained (e.g., classification method, error determination method, etc.) and also runs the training. The training module 118 takes as input the raw training data from the database 119 and trains the second NN 115 to identify roles based on detecting background noise patterns in audio message. As an example, the background noise pattern for a driver may be the constant sound of an engine running because the driver is most likely always in the race car with the engine running during the race. As another example, the background noise pattern for a spotter may be constant crowd noise because the spotter is likely watching the race from a position near crowds and, thus, any audio that captures background noise patterns of constant crowd noise is likely form the spotter.

The speaker role determiner 113 is used for determining roles of one or more speakers in the messages by at least one of: applying the first NN 114 to a plurality of converted text messages to determine roles of some speakers based on analysis of specific words and/or phrases in the text messages, and applying the second NN 115 to the plurality of audio messages to determine roles of other speakers based on analysis of background noise patterns in the audio messages.

For example, as mentioned above, different roles may be roles assigned to drivers, pit crew, engineers, spotters (race watchers), etc. Based on their respective roles, specific phrases are relevant for each team member. In addition, background noise patterns from the audio stream received from the driver, crew, spotter, etc., can be used to recognize roles of speakers of the messages. For instance, the engine noise may be used for a member whose role is a driver. For pit crew or engineer, the content of the message, existence of typical words or jargons used by pit crew and engineers, etc. can also be used to identify the role of the message. In one aspect, the background noise may be used for differentiating between drivers and engineers.

In one aspect, the third NN 121 is trained, via the training module 122, to recognize topics based on racing data.

In one aspect, the training module 122 may be a script or code that holds instructions on how the third NN for recognizing topics based on racing data should be trained (e.g., classification method, error determination method, etc.) and also runs the training. The training module 122 takes as input the raw training data from the database 123 and trains the third NN 121 to recognize topics based on racing data. In one aspect, the keywords are identified via a text search mechanism by the keyword identifier 140 by executing a text search in database 132 which contains previously stored keywords for racing communication.

For ease of understanding, concepts of ML modules relevant to the present disclosure are briefly described herein. In general, ML modules of the present disclosure may comprise one or more machine learning algorithms, which can broadly be categorized into three main types: algorithms for supervised learning, unsupervised learning, and reinforcement learning.

Supervised learning is effective for tasks such as classification (assigning inputs to predefined categories) and regression (predicting continuous values). It relies on the availability of labeled data for both training and evaluation phases. In supervised learning, machine learning modules train the algorithm on a labeled dataset, where each input has a corresponding output. The goal is to learn a mapping function from inputs to outputs, allowing the algorithm to make predictions or classifications on new, unseen data. The process typically involves the following steps: training, model building, prediction, feedback, and adjustment. In the training phase, the ML module provides the algorithm with a training dataset including input-output pairs. The algorithm learns the mapping function that relates inputs to outputs through an iterative process, adjusting its internal parameters based on the provided examples. During model building, the algorithm creates a model that can generalize from the training data to make predictions on new, unseen data. The model's complexity varies based on the algorithm used. For example, the model may be a simple linear regression model or a complex neural network. During the prediction phase, ML module inputs test inputs (i.e., inputs with known outputs) into the model, which generates predictions or classifications based on what it has learned during training. The accuracy of predictions is evaluated by comparing them to the known outputs in a validation or test dataset. During the feedback and adjustment phase, the ML module refines the model based on feedback from its predictions. If the predictions differ from the actual outputs, the algorithm adjusts its internal parameters to minimize the errors. The performance of the trained model is assessed using metrics such as accuracy, precision, recall, etc., depending on the nature of the problem.

Unsupervised learning is valuable for tasks where the goal is to explore the inherent structure of the data, identify hidden patterns, or pre-process data for further analysis. It doesn't require labeled examples but relies on the algorithm's ability to discern meaningful structures within the input data. Unsupervised learning deals with unlabeled data, aiming to discover patterns, structures, or relationships within the dataset. Clustering and dimensionality reduction are common tasks in unsupervised learning, helping to reveal inherent structures without predefined target labels. The typical process for unsupervised learning includes: data collection, analysis (e.g., using clustering, dimensionality reduction, etc.) and association. For example, the ML module receives a dataset including only input features without corresponding output labels. The ML module then performs exploratory data analysis to understand the inherent structure of the data. Common techniques in this analysis include statistical measures, clustering, and dimensionality reduction. For example, in clustering, the algorithm groups similar data points together based on certain features. Algorithms including, but not limited to, k-means clustering and hierarchical clustering are commonly used for grouping. In dimensionality reduction, the algorithm reduces the number of input features while retaining essential information. For example, the algorithm may use techniques like Principal Component Analysis (PCA) or t-distributed Stochastic Neighbor Embedding (t-SNE) for dimensionality reduction. During the association phase, the algorithm discovers relationships or associations between variables in the analyzed data. In some aspects, unsupervised learning is used in generative neural networks (e.g., generative adversarial networks (GANs)) to generate new data points similar to the existing dataset once the characteristics of the existing dataset are learned.

Referring back to FIG. 1, in some aspects, the computing device 110 utilizes reinforcement learning, in which the optimal decision-making strategy is learned through trial and error, without explicit guidance. Reinforcement learning involves an agent learning to make decisions by interacting with an environment. The agent receives feedback in the form of rewards or penalties based on its actions, allowing it to learn optimal strategies through trial and error. The primary components of reinforcement learning are as follows: agent, environment, state, action, reward, exploration and exploitation, learning policy, and value function. An agent is the entity that takes actions in the environment - it is the learner in the system. The environment is the external system with which the agent interacts. The external system provides feedback to the agent based on the actions taken. The state is a representation of the current situation or configuration of the environment. Actions are the moves or decisions that the agent can take within the environment. A reward is a numerical signal that indicates the immediate benefit or cost of the agent's action. The agent's objective is to maximize the cumulative reward over time. The reinforcement learning process typically involves the following steps. The agent explores the environment to discover the most rewarding actions (exploration) and exploits its current knowledge to take actions it believes will yield the highest cumulative reward (exploitation). The agent learns a policy, which is a strategy that maps states to actions, based on the observed rewards and its exploration-exploitation trade-offs. The agent may also learn a value function, estimating the expected cumulative reward from a given state or state-action pair.

In ML based analysis by computing device 110, the objective is to minimize both the errors that take place in providing messages according to their relevance and importance to specific team members. The team members take actions based on the messages that are displayed. Thus, minimizing errors is essential for improving the communication among team members. In a subsequent step, after an action is performed based on displayed messages, a determination may be made on whether or not the messages were displayed according to the relevance for the team member. If so, the method is performing successfully. If not, the information is stored for improving the training of the algorithm thereby improving the outcome overtime. Therefore, postprocessing of data is useful for improving the efficiency of the method of the present disclosure.

The ML-based analysis of the racing communications of the present disclosure is performed using one or more NNs that are first trained on a large training dataset and fine-tuned for a special purpose for the special purpose based on specific data. For each special purpose, the respective ML module for the include a classification module, an error determination module, and an inference module. The classification and error determination modules are used during a training phase while the inference module is used during a production phase. For instance, during the training phase, first, the classification module is trained on a large dataset. Then, in order to reduce the risk of model overfitting of the training dataset, the model is validated using testing dataset with known outcomes and the error determination module. Once the accuracy of the classification module is considered acceptable, the inference module is ready to process unseen data. In order to expedite the training, improve accuracy, and reduce the amount of unseen data that cannot be classified, the classifier is initially trained on a large dataset, such as a large dataset of racing data (e.g., thousands of messages). Then, finetuning is performed based on data similar to the environment in which the ML module is to be used. For example, for the present disclosure, the initial training may be based on audio messages gathered for any application. For the finetuning step, racing data may be used. In some cases, the racing data may be further finetuned for a special type of racing, such as, for boat racing, car racing, bike racing, etc.

In one aspect, a list of keywords associated with messages and roles of the speakers of the messages is determined by a user of a system providing the racing communication. In one aspect, the user provides the list of keywords via the UI. In one aspect, the user may establish the list of keywords using a search engine or a PostgreSQL text search engine that enables the user to limit the search to the user's database.

In one aspect, the list of keywords associated and the roles of messages is determined using a customized topic model for the type of racing. Topic modeling refers to various methods of determining “topics” within a collection of documents and involves examining the text within the documents to detect patterns and relationships that indicate the presence/absence of the desired topics. BERTopic is a specific modeling technique for simplifying the process of applying the topic modeling. BERTopic includes various embedding techniques and class-based Time Frequency - Inverse Document Frequency (TF-IDF) techniques to create dense clusters, allowing for interpretable topics while keeping important words in the topic descriptions. BERTopic can be used to analyze latent topics in clusters of varying densities to extract topics with the most relevant keywords. As an example, using BERTopic, the system 100 may filter out common messages that are deemed to be not informative (e.g., not important).

It should be noted that the identification of a role is not equivalent to an identification of a specific person, such as driver 1 versus driver 2. Instead, the term “role” means identification of the person having a role of a driver and not an engineer or pit crew. In one aspect, names of members may also be used to identify the role. For example, if a member is known to be part of the pit-crew and is uttering certain words, the role of the speaker can be determined, in part, based on identifying the person generating the message.

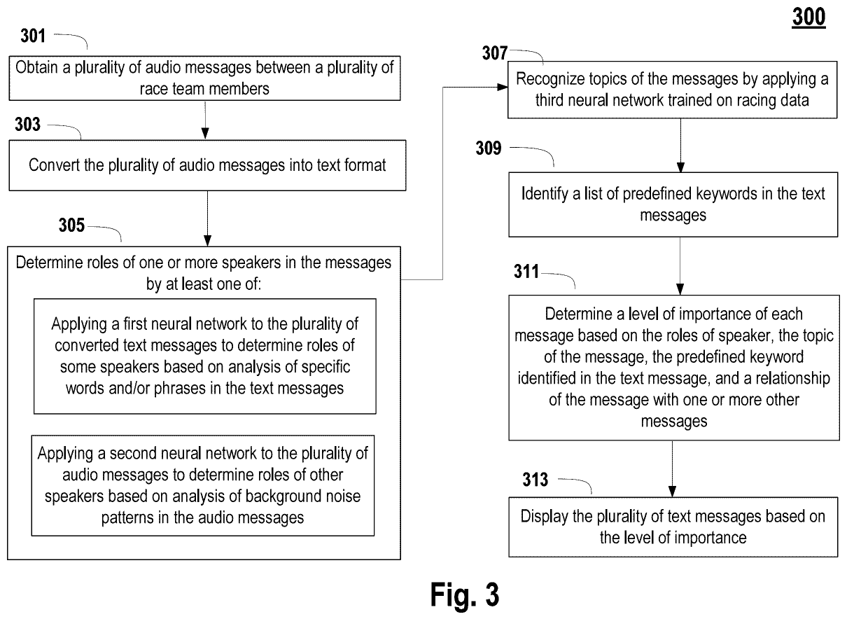

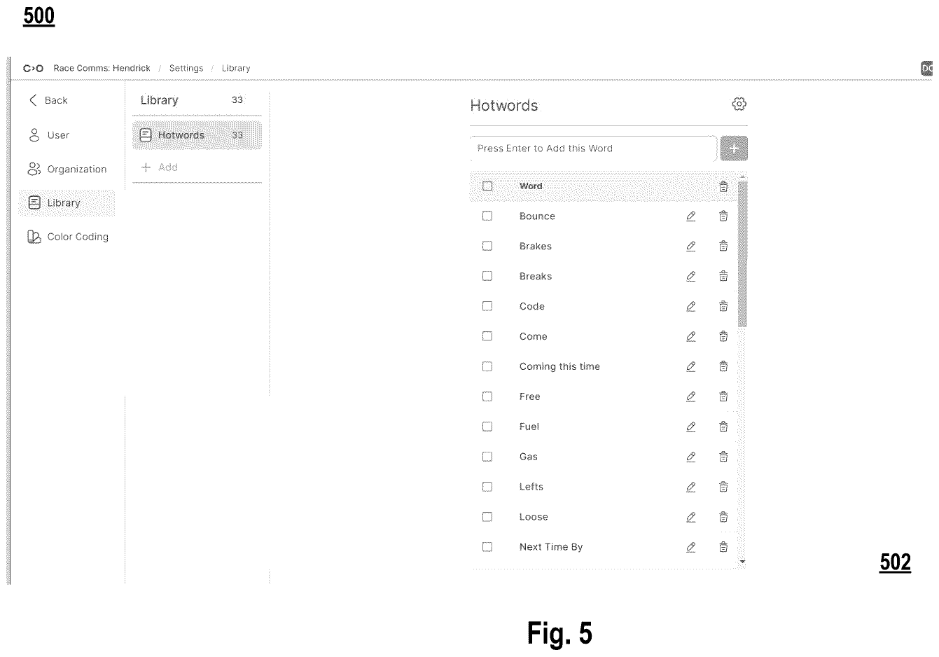

FIG. 3 is a flow diagram of method for ML based analysis of racing communication. In various implementations, the method 300 is performed by a device (e.g., computer system 2 shown in FIG. 5) with one or more processors and non-transitory memory that performs intent prediction. In some implementations, the method 300 is performed by processing logic, including hardware, firmware, software, or a combination thereof. In some implementations, the method 300 is performed by a processor executing code stored in a non-transitory computer-readable medium (e.g., a memory). The method 300 describes transcribing, tracking, and analyzing live radio communication between racers and their support teams during a race.

In step 301, method 300 includes obtaining a plurality of audio message between a plurality of race team members. As an example, referring back to FIG. 1, the computing device 110 may obtain the plurality of messages via an audio monitoring module 111.

In step 303, method 300 includes converting the plurality of audio messages into text format. As an example, referring back to FIG. 1, the computing device 110 may convert the audio messages into text via an audio to text converter 112.

In step 305, method 300 includes determining roles of one or more speakers in the messages, including at least one of: applying a first neural network to the plurality of converted text messages to determine roles of some speakers based on analysis of specific words and/or phrases in the text messages, and applying a second neural network to the plurality of audio messages to determine roles of other speakers based on analysis of background noise patterns in the audio messages. As an example, referring to FIG. 1, the speaker role determiner 113 is configured to include a first trained NN (e.g., the first NN 114 shown in FIG. 2) to determine roles of speakers based on detecting particular words and/or phrases from the text messages and the topic recognizer 120 is configured to include a second trained NN (e.g., the second NN 115 shown in FIG. 2) to determine roles of other speakers based on analysis of background noise patterns in the audio messages.

In some aspect, the training of the first neural network to identify the roles of some speakers includes: training a large language model using phrases used by race team members having specific roles based on recognition of phrases used by the one or more race team members using an automatic speech recognition engine, and fine-tuning the resulting large language model using a race dataset using Low-Rank Adaptation (LoRA) techniques. As an example, referring to FIG. 2, the training module 116 may be used to train the first NN 114 to identify roles based on words and phrases in text using training datasets from a database 117 of phrases used by race team members having specific roles.

In some aspects, the training of the second neural network to identify roles of other speakers is based on one or more audio clips produced by VAD (Voice Activity Detection). As an example, referring to FIG. 2, the training module 118 may be used to train the second NN 115 to identify roles based on background noise patterns in audio messages using training datasets from a database 119 of audio clips produced by VAD.

In step 307, method 300 includes recognizing topics of the messages by applying a third neural network trained on racing data to the plurality of converted text messages. As an example, referring to FIG. 2, the training module 122 may be used to train the third NN 121 for recognizing topics based on racing data using training datasets from the database 123 of racing data.

In step 309, method 300 includes identifying a list of predefined keywords, by text search mechanism, in the text messages.

In some aspects, the identifying the predefined keywords further includes: applying a third neural network to the converted text messages to identify the predefined keywords in the texts of each message. In one aspect, if a message includes a “hotword” then the message may be tagged with an important tag. As an example, referring back to FIG. 1, the keyword identifier 140 may be used to apply a third NN (e.g., third NN 121 for recognizing topics based on racing data shown in FIG. 2) to the text messages to identify a “hotword” within the text of each message.

In some aspects, the roles of the one or more speakers in the messages is determined using a customized topic classification model to build a customized topic model for the type of racing.

In some aspects, the topic classification model comprises a BERT-based Topic Modeling (BERTopic) model. A BERTopic is a topic modeling technique that leverages BERT embeddings to create dense representations of text, which are then clustered to identify topics. BERTopic is designed to provide more coherent and meaningful topics compared to other topic modeling methods like Latent Dirichlet Allocation (DLA). As an example, referring back to FIG. 1, the topic recognizer 120 may be configured to contain a BERTopic.

In step 311, the method 300 includes determining a level of importance of each message based on the role of the speaker, the topic of the message, the predefined keywords identified in the text message, and a relationship of the message with one or more other messages. As an example, referring back to FIG. 1, the importance level assigner 150 may be used to determine a level of importance of each message based on different criteria.

In one aspect, the determination of a speaker's role may determine whether their audio communication is important or not important. For example, if the speaker's role is a spotter, then all messages from the spotter may be tagged with low importance by default. As another example, if the speaker's role is a driver, then all messages from the driver may be tagged with high important by default.

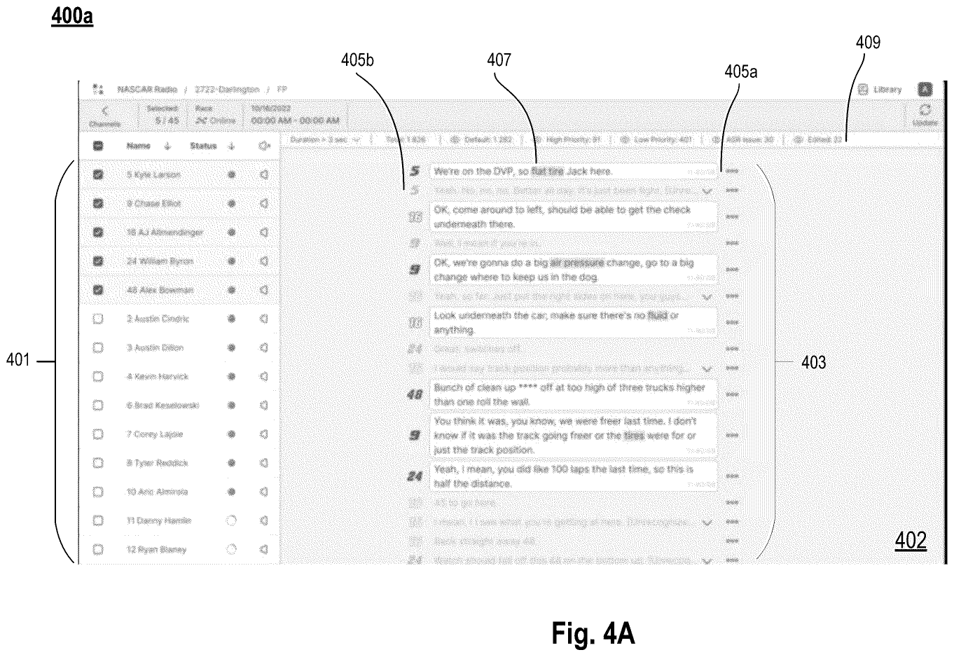

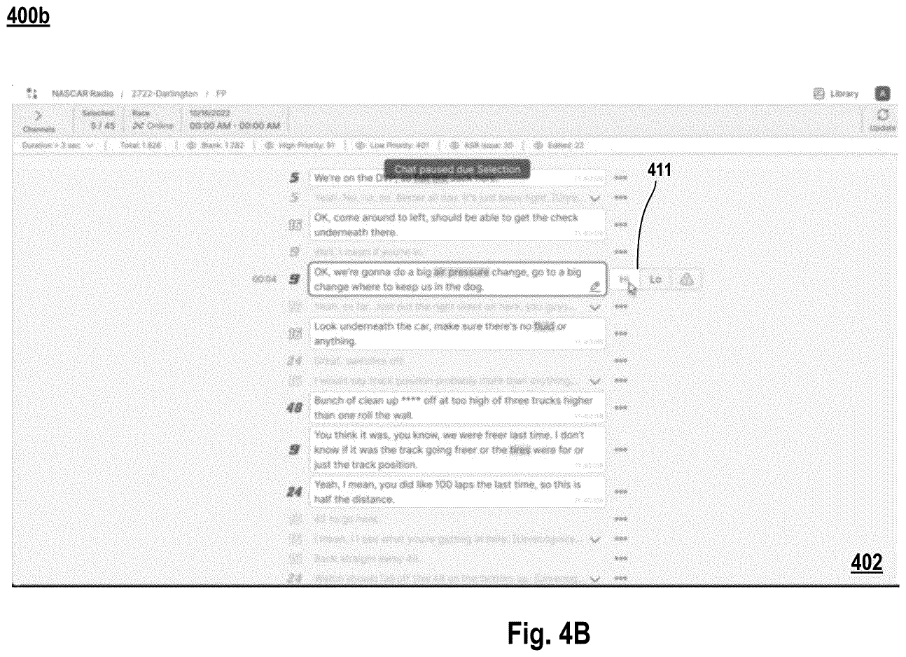

In step 313, the method 300 includes displaying the plurality of text messages based on the level of importance in a UI. As an example, the UI displaying the text messages based on the level of importance will be described in more detail in FIGS. 4A-4B. As another example, referring back to FIG. 1, the UI 190 may generate and display the plurality of text messages that are visually indicated to highlight important messages.

In some aspects, the displaying the messages to the team member further includes: displaying a role of the speaker, highlighting the identified keywords contained in the message, and identifying the level of importance of the topic of the message. As an example, referring to FIG. 4a, the transcript UI 402 displays the message 405a with highlights on the identified keywords 407.

In some aspects, the method further comprises: playing back the audio of the messages. In some aspects, the method further comprises: playing back audio of the original audio stream received from the Internet, streaming services, or the cloud server.

In some aspects, the method further comprises: capturing telemetric information for a vehicle of a race, and displaying the telemetric information in the UI.

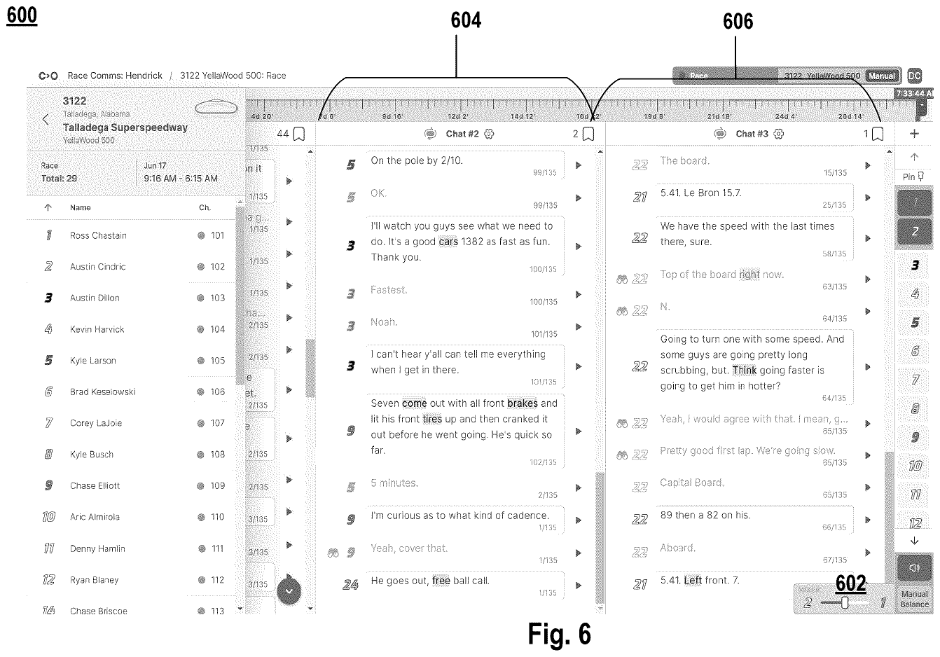

In some aspects, the UI enables a team member of the one or more race team members to switch among messages from different vehicles of the racing event. As an example, referring to FIG. 6, the UI displays a team member that is viewing two different chats 604, 606.

In some aspects, the UI further includes one or more interfaces for displaying real-time videos of each respective vehicle in a race.

In some aspects, the UI further includes a map showing a geolocation of the vehicle on a track of the race.

In some aspects, the UI further includes one or more interfaces for receiving telemetry data for each vehicle during the racing event, the telemetry data including at least one of: a speed of the vehicle, an acceleration of the vehicle, a number of laps of the vehicle, a geolocation of the vehicle, and parameters of the vehicle. In some aspects, the telemetric information further comprises information related to a state of the race, for instance, a flag, a leading vehicle's lap number, etc.

In some aspects, the analysis of the race communication and display of text messages on the UI is performed in real-time during a race.

In one aspect, phrases used by various members are recognized using an automatic speech recognition service such as any cloud computing platform and service known in the art. Then, as described above, the ML model is finetuned using the race dataset.

In one aspect, a recording of a radio/audio channel may be for a duration of time spanning the entire race, which may be over any number of days. For example, a car racing event may span several days. Thus, each channel is monitored during the entire race and all audio/radio communication is recorded.

In some aspects, the steps of recording all radio/audio channels during the racing event for monitoring messages associated with each vehicle of a plurality of vehicles associated with a racing event, recognizing messages in audio streams for all the recorded channels, and converting the recognized messages to texts, and identifying roles of the messages based on analysis of the texts, the analysis being performed using an AI model trained to identify roles of messages based on specific phrases used by members having respective roles, are performed for the first message. Once the role of the message is recognized, an association with a specific speaker is maintained. The information may then be used for processing subsequent messages gathered from the audio channel of the given speaker. Thus, for subsequent speakers, the analysis of the messages includes:
identifying keywords in the texts; identifying topics of the messages; determining, for each message, by a rules engine, a level of importance for the message based on the identified role of the message, keywords associated with the message, the determined topics, and relationships of the message with any number of other messages; assigning, to each message, by the rules engine, a level of importance of the message based on the role of a speaker of the message, presences of one or more keywords, and a level of importance of determined topic; receiving, via a UI from the team member, a selection for displaying to the team member; and displaying, to the team member, messages having a highest level of importance in accordance with the selection received from the team member.

FIGS. 4A-B illustrates an exemplary screenshot of a UI displaying a transcript from near real-time audio communication of team members in accordance with aspects of the present disclosure. As shown in example 400a, a transcript UI 402 may help display the most pertinent communication by filtering out irrelevant communications and highlight the important messages as detected by trained neural networks.

Specifically, example 400a of FIG. 4A shows a transcript of near real-time live radio communication between team members. The transcript UI 402 shows a transcript of all spoken communication that has been converted into text with acceptable latency to ensure that no message is missed and for easier tracking during the race. The transcript UI 402 may also display identified and highlighted key messages based on predefined criteria set by the racing team or by using a neural network (e.g., the third NN 121 for recognizing topics based on racing data as shown in FIG. 2 or importance level assigner 150 from FIG. 1).

Specifically, as shown in example 400a, the transcript UI 402 may display messages transcribed from real-time audio message of team members during a particular race. As an example, a first portion 401 of the transcript UI 402 may list all of the team members and each team member may be filtered to be omitted or included in the transcript. In addition, within the first portion 401 of the transcript UI 402, each team member may have their name listed, an indication status (green—online or blank—offline), an option to be muted (e.g., not included in the transcript), and/or an assigned role (not pictured).

As shown in the second portion 403 of the transcript UI 402, the transcript may contain text messages of the audio messages of selected team members during a race. In particular, the text messages may be categorized into important (e.g., high priority) 405a or not important (e.g., low priority) 405b. In one aspect, the important messages 405a are identified by the third neural network (e.g., third NN 121 from FIG. 2) based on recognizing topics in the text messages. Since there are so many different messages going on during the race, it is beneficial to highlight the important messages 407 and dim or “mute” the not important messages 405b in the transcript. In one example, a detection of terms such as “flat tire” 407, “air pressure”, “fluid”, or “tires” will automatically prioritize the message as an important message 405a.

As shown in the third portion 409 of the transcript UI 402, there may be an information bar that list statistics for the transcript. As a non limiting example, the information bar may include transcript descriptions such as the time, the date, the particular race, and race statistics such as duration of the listed transcript, total number of words detected, total number of high priority messages, total number of low priority messages, or the like.

In addition to showing a near-time transcript of the audio communication during the race, the transcript UI 402 may also be used in post-race analysis or as additional training data for future races. The recordings of the audio communication may be available as text and/or audio.

As shown in example 400b of FIG. 4B, the transcript may be edited in post-race analysis in order to include or remove key words. In one aspect, a user may change the importance of a key word using a selection button 411.

FIG. 5 illustrates an exemplary screenshot of a UI displaying “hotwords” from a transcript in accordance with aspects of the present disclosure. The UI 502 may allow collect feedback gathered from users during a post-race analysis.

As shown in example 500 of FIG. 5, a dictionary or library may determine the amount of times that keywords appear in the transcript. The dictionary or library may be stored in a database (e.g., database 117 of phrases used by race team members having specific roles or topics database 132 shown in FIG. 1) for training. This process is typically done during post-race analysis in order to generate more accurate training data to train the neural networks (e.g., first NN 114 for identifying roles based on words and phrases in text and/or third NN 121 for recognizing topics based on racing data). In one aspect, a user may manually add their own keywords into the dictionary or library. In one aspect, a user may also run search queries on specific keywords in the transcript.

FIG. 6 illustrates an exemplary screenshot being displayed via a user interface to a team member in accordance with aspects of the present disclosure. As shown in example 600 of FIG. 6, a team member is viewing chats 2 604 and 3 606 for a race identified as “YellaWood” on the user interface 602. If the team member interacts with the computing device 110 and selects another chat, another race, another vehicle, etc., messages from the newly selected race, chat, vehicle, etc. will be displayed to the team member.

In one aspect, the present disclosure gathers audio messages exchanged among members of a team associated with a racing activity, generates results based on an ML based analysis of racing communication, e.g., audio messages exchanged among team members, and displays messages to team members (in text format) based on a level of importance assigned to each message.

In one aspect, the analysis of the plurality of messages comprises: analyzing the plurality of messages in real-time, the analysis including processing each message based on a relevance of the respective message for a given team member, and displaying, for each team member, the messages based on a level of importance of the message to the respective team member (i.e., the importance of the message for the role assigned to the particular team member).

In one aspect, the analysis of the plurality of messages further comprises: a postrace processing of the messages. The postrace processing of the messages may be performed in addition to the real-time analysis of the messages. For example, a more detailed analysis may be performed to improve efficiency in communication and to enable the algorithm of the model to learn from decisions made in real-time.

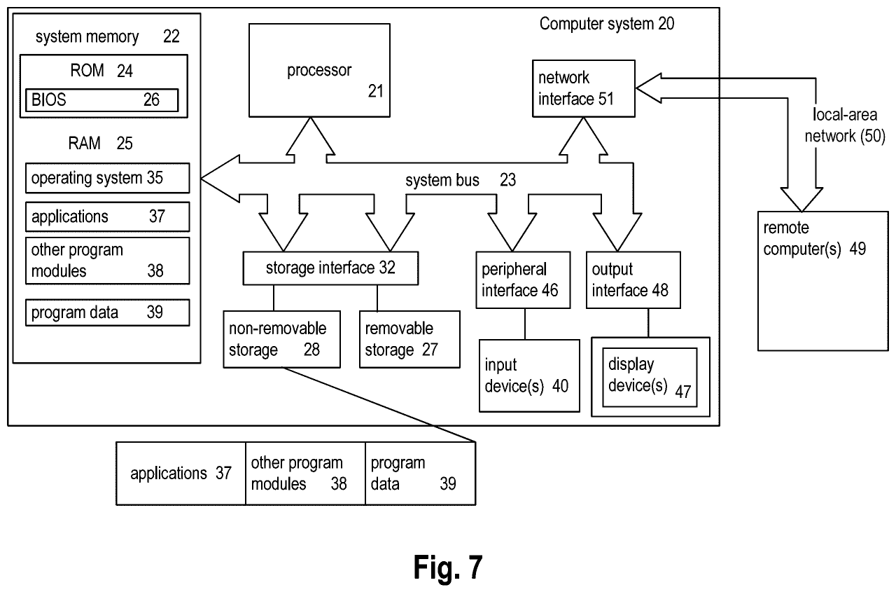

FIG. 7 is a block diagram illustrating a computer system 20 on which aspects of systems and methods for machine learning (ML) based analysis of racing communications may be implemented in accordance with an exemplary aspect. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-6 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for ML-based analysis of racing communications in a racing event, the method comprising:
obtaining a plurality of audio message between a plurality of race team members;
converting the plurality of audio messages into text format;
determining roles of one or more speakers in the audio messages, including at least one of:
applying a first neural network to the plurality of converted text messages to determine roles of some speakers based on analysis of specific words and/or phrases in the text messages; and
applying a second neural network to the plurality of audio messages to determine roles of other speakers based on analysis of background noise patterns in the audio messages;
recognizing topics of the audio messages by applying a third neural network trained on racing data to the plurality of converted text messages;
identifying a list of predefined keywords, by text search mechanism, in the text messages;
determining a level of importance of each message based on the role of the speaker, the topic of the message, the predefined keywords identified in the text message, and a relationship of the message with one or more other messages; and
displaying the plurality of text messages based on the level of importance in a user interface.

2. The method of claim 1, wherein the displaying the messages to the race team member further includes:
displaying a role of the speaker;
highlighting the identified keywords contained in the message; and
identifying the level of importance of the topic of the message.

3. The method of claim 1, wherein the list of predefined keywords in the text messages and the roles of the one or more speakers in the messages is determined using a customized topic classification model to build a customized topic model for the type of racing.

4. The method of claim 1, further comprising:
capturing telemetric information for a vehicle of a race; and
displaying the telemetric information in the user interface.

5. The method of claim 1, wherein the training of the first neural network to identify the roles of some speakers includes:
training a large language model using phrases used by race team members having specific roles based on recognition of phrases used by the race team members using an automatic speech recognition engine; and
fine-tuning the trained large language model using a race dataset using Low-Rank Adaptation (LoRA) techniques.

6. The method of claim 1, wherein the training of the second neural network to identify roles of other speakers is based on one or more audio clips produced by VAD (Voice Activity Detection).

7. The method of claim 1, wherein the user interface enables a team member of the race team members to switch among messages from different vehicles of the racing event.

8. The method of claim 1, wherein the user interface further includes one or more interfaces for displaying real-time videos of each respective vehicle in a race.

9. The method of claim 1, wherein the user interface further includes a map showing a geolocation of a vehicle on a track of a race in the racing event.

10. The method of claim 8, wherein the user interface further includes one or more interfaces for receiving telemetry data for each vehicle during the racing event, the telemetry data including at least one of: a speed of the vehicle, an acceleration of the vehicle, a number of laps of the vehicle, a geolocation of the vehicle, and parameters of the vehicle.

11. The method of claim 1, wherein the analysis of the race communication and display of text messages on the user interface is performed in real-time during a race.

12. A system for ML-based analysis of racing communications, comprising:
at least one memory;
at least one hardware processor coupled with the at least one memory and configured, individually or in combination, to:
obtain a plurality of audio message between a plurality of race team members;
convert the plurality of audio messages into text format;
determine roles of one or more speakers in the messages, including at least one of:
applying a first neural network to the plurality of converted text messages to determine roles of some speakers based on analysis of specific words and/or phrases in the text messages; and
applying a second neural network to the plurality of audio messages to determine roles of other speakers based on analysis of background noise patterns in the audio messages;
identify a list of predefined keywords, by text search mechanism, in the text messages;
apply a third neural network to the converted text messages to identify the predefined keywords in the texts of each message;
determine a level of importance of each message based on the role of the speaker, a topic of the message, the predefined keywords identified in the text message, and a relationship of the message with one or more other messages; and
display the plurality of text messages based on the level of importance in a user interface.

13. The system of claim 12, wherein the displaying of the messages to the team member further includes:
displaying a role of the message;
highlighting of keywords contained in the message; and
the level of importance of the topic of the message.

14. The system of claim 12, wherein the list of predefined keywords in the text messages and the roles of the one or more speakers in the messages is determined using a customized topic classification model to build a customized topic model for the type of racing.

15. The system of claim 12, the processor further configured to:
capture telemetric information for a vehicle of a race; and
display the telemetric information in the user interface.

16. The system of claim 12, wherein the training of the first neural network to identify the roles of some speakers includes:
training a large language model using phrases used by race team members having specific roles based on recognition of phrases used by the one or more race team members using an automatic speech recognition engine; and
fine-tuning the trained large language model using a race dataset using Low-Rank Adaptation (LoRA) techniques.

17. A non-transitory computer readable medium storing thereon computer executable instructions for ML-based analysis of racing communications, including instructions for:
obtaining a plurality of audio message between a plurality of race team members;
converting the plurality of audio messages into text format;
determining roles of one or more speakers in the messages, including at least one of:
applying a first neural network to the plurality of converted text messages to determine roles of some speakers based on analysis of specific words and/or phrases in the text messages; and
applying a second neural network to the plurality of audio messages to determine roles of other speakers based on analysis of background noise patterns in the audio messages;
identifying a list of predefined keywords, by text search mechanism, in the text messages;
applying a third neural network to the converted text messages to identify the predefined keywords in the texts of each message;
determining a level of importance of each message based on the role of the speaker, the topic of the message, the predefined keywords identified in the text message, and a relationship of the message with one or more other messages; and
displaying the plurality of text messages based on the level of importance in a user interface.

18. The non-transitory computer readable medium of claim 17, wherein the displaying the messages to the team member further includes:
displaying a role of the speaker;
highlighting the identified keywords contained in the message; and
identifying the level of importance of the topic of the message.

19. The non-transitory computer readable medium of claim 17, wherein the list of predefined keywords in the text messages and the roles of the one or more speakers in the messages is determined using a customized topic classification model to build a customized topic model for the type of racing.

20. The non-transitory computer readable medium of claim 17, the instructions including instructions for:
capturing telemetric information for a vehicle of a race; and
displaying the telemetric information in the user interface.
